(19) United States
(12) Patent Application Publication
(10) Pub. No.: US 2020/0398090 A1
(43) Pub. Date: Dec. 24, 2020

(54) CERAMIC FOAM FLAME ARRESTOR ASSEMBLY FOR FLAMMABLE STORAGE CABINET

(71) Applicant: Kewaunee Scientific Corporation, Statesville, NC (US)

(72) Inventors: Kurt P. Rindoks, Statesville, NC (US); Matthew L. Warren, Statesville, NC (US)

(21) Appl. No.: 16/905,094

(22) Filed: Jun. 18, 2020

Related U.S. Application Data
(60) Provisional application No. 62/864,629, filed on Jun. 21, 2019.

(51) Int. Cl. A62C 2/06; A62C 4/00

(52) U.S. Cl. CPC A62C 2/06; B01L 1/50; A62C 4/00

(57) ABSTRACT

A storage cabinet for ignitable (flammable) liquids is provided. The cabinet comprises a flame arrestor assembly having a bung, a perforated disk, a sleeve, and a ceramic filter. The storage cabinet has an inner or an outer wall, and the flame arrestor assembly sets between the inner wall and the outer wall of the cabinet. A method of using a flame arrestor assembly in a storage cabinet for ignitable (flammable) liquids is also provided.

### CROSS-REFERENCE TO RELATED APPLICATION

This application claims priority from U.S. Provisional Patent Application No. 62/864,629, filed on Jun. 21, 2019, in the United States Patent and Trademark Office. The disclosure of which is incorporated herein by reference in its entirety.

### FIELD OF THE INVENTION

The present invention relates to a flame arrestor assembly and a method for using the same. More particularly, the present invention relates to a ceramic foam flame arrestor assembly and a flammable storage cabinet containing the ceramic foam flame arrestor assembly and a method of using a ceramic foam flame arrestor assembly within a flammable storage cabinet.

### BACKGROUND OF THE INVENTION

A flame arrestor is a device that absorbs the heat from a flame or spark passing through a gas/air mixture so that the temperature is below the mixture's auto-ignition temperature, which effectively extinguishes the flame. Typically, a flame arrestor is made with metal because of the high thermal conductivity these metals have. The design must be so that, as the flame passes through the flame arrestor, the flame arrestor cools the gas/air mixture below the auto-ignition temperature. These designs include, for example, perforated sheet metal plates, wire mesh, crimped ribbons, etc. Flame arrestors are a safety device used in many types of industries. Each flame arrestor is designed specifically for the application in which it will be used.

In the industry, there is a debate about whether or not flammable storage cabinets should be vented. From the health and safety perspective, it is believed that flammable storage cabinets should be vented because the liquids stored in them generate a small amount of potentially hazardous gas that users could breathe. From the fire safety side, it is recommended that these cabinets not be vented because of the fire hazard that a venting system potentially filled with flammable gases could cause. All flammable storage cabinets have flame arrestors and bungs to seal the cabinet if it is not being vented.

A flame arrestor prevents a flame or spark from traveling into a vented cabinet and igniting the flammable liquids stored inside the cabinet, or if the flame is in the cabinet the arrestor will prevent the flame's spread to the duct work. Due to the harsh nature of the chemicals being stored in these types of cabinets, corrosion is a major concern. A corroded material may not function adequately or may become severely damaged to the point it can no longer function as needed.

Thus, there is a need for an alternative flame arrestor that overcomes the above referenced problems and concerns.

### SUMMARY OF THE INVENTION

The present invention relates to a ceramic foam flame arrestor assembly and a flammable storage cabinet containing the ceramic foam flame arrestor assembly as well as a method for using the same.

By using ceramic foam as the material that is cooling the air, corrosion is not an issue. Ceramic is an inert material that does not react with other chemicals and it has high thermal conductivity.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 illustrates a flammable storage cabinet containing a flame arrestor assembly.

FIG. 2 illustrates an isometric view of a flame arrestor assembly.

FIG. 3 illustrates an exploded view of the flame arrestor assembly of FIG. 2.

FIG. 4 illustrates a side view of the flame arrestor assembly of FIG. 2.

FIG. 5 illustrates a front view of the flame arrestor assembly of FIG. 2.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

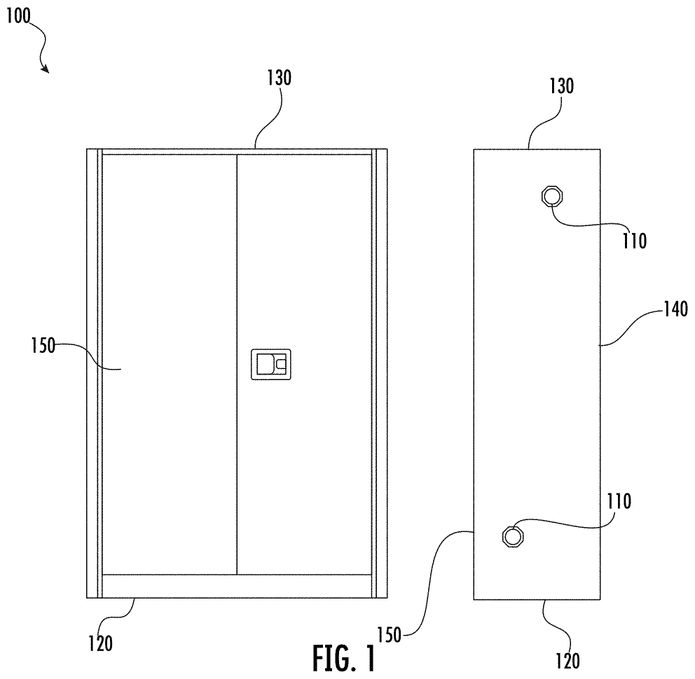

FIG. 1 shows an embodiment of a flammable storage cabinet 100. The flammable storage cabinet 100 comprises the arrestor flame assembly 110 having a ceramic foam filter. The arrestor flame assembly 110 is present in the flammable storage cabinet 100. The arrestor flame assembly 110 is inserted or screwed into the flammable storage cabinet 100. The arrestor flame assembly 110 is positioned between an outer wall and an inner wall of the flammable storage cabinet 100 with an end of the ceramic foam filter positioned against the inner wall. The inner wall has a plurality of holes where the ceramic foam of the ceramic foam filter may touch the inner cabinet wall. Each hole typically may have a diameter in a range of 0.1 in. to 0.4 in. For example, the inner wall may have 13 holes with preferably having a diameter of 0.244 in. (6 mm).

FIG. 1 illustrates a flammable storage cabinet 100 containing a flame arrestor assembly 110. FIG. 1 is an example of a 90-gallon cabinet that is 43 inches wide by 65 inches high by 18 inches deep. The flammable storage cabinet may comprise a bottom surface 120, a top surface 130, a back surface 140, and a front surface 150. FIG. 1 illustrates the ceramic foam arrestor assembly 110 present in an upper left-hand end panel and/or present in a lower right-hand end panel of the flammable storage cabinet 100. As shown in FIG. 1, in the case of the ceramic foam arrestor assembly 110 present in an upper left-hand end panel, the ceramic foam arrestor assembly 110 may be present 6 to 8 inches from the back surface 140 of the flammable storage cabinet 100, may be 6 to 8 inches down from the top surface 130 of the flammable storage cabinet, or a combination thereof. As shown in FIG. 1, in the case of the ceramic foam arrestor assembly 110 present in lower right-hand end panel, the ceramic foam arrestor assembly 110 may be present 4 to 6 inches from the front surface 150 of the flammable storage cabinet 100, may be 8 to 10 inches up from the bottom surface 120 of the cabinet 100, or a combination thereof. This is just an example. Alternatively, the actual location of the flame arrestor assembly 110 could vary with manufacture and/or based on the size of the flammable storage cabinet 100. The locations of the ceramic foam arrestor assemblies 110 can be diametrically opposed and can be located on the end panels or on a rear panel.

In accordance with the invention, if a flame reaches the flame arrestor assembly 110, the ceramic foam within the flame arrestor assembly 110 acts as a heat sink and cools the gas/air mixture to below the temperature that the mixture needs to ignite, also known as the auto-ignition temperature. Once the gas/air mixture is below the auto ignition temperature, the gas/air mixture cannot re-ignite the flame without an external ignition source, such as a spark.

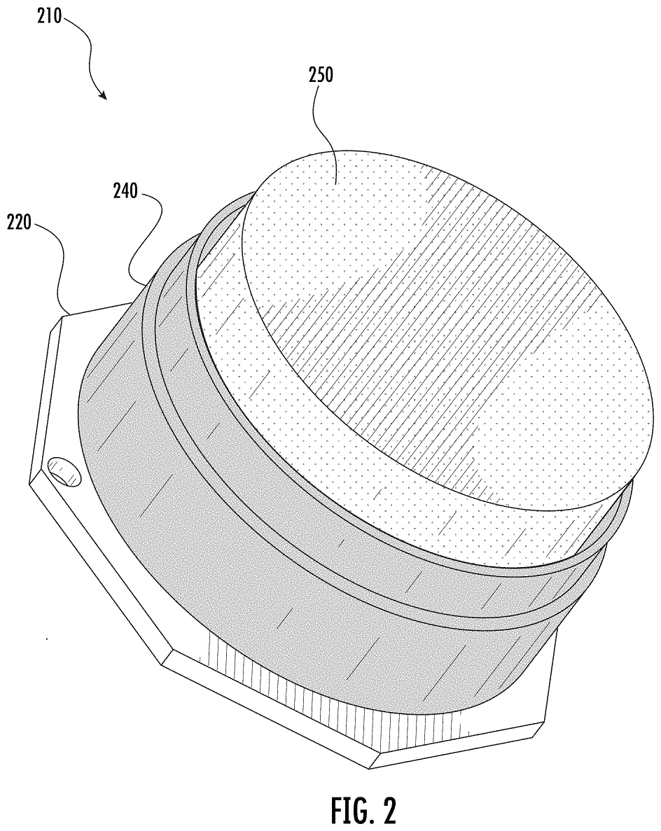

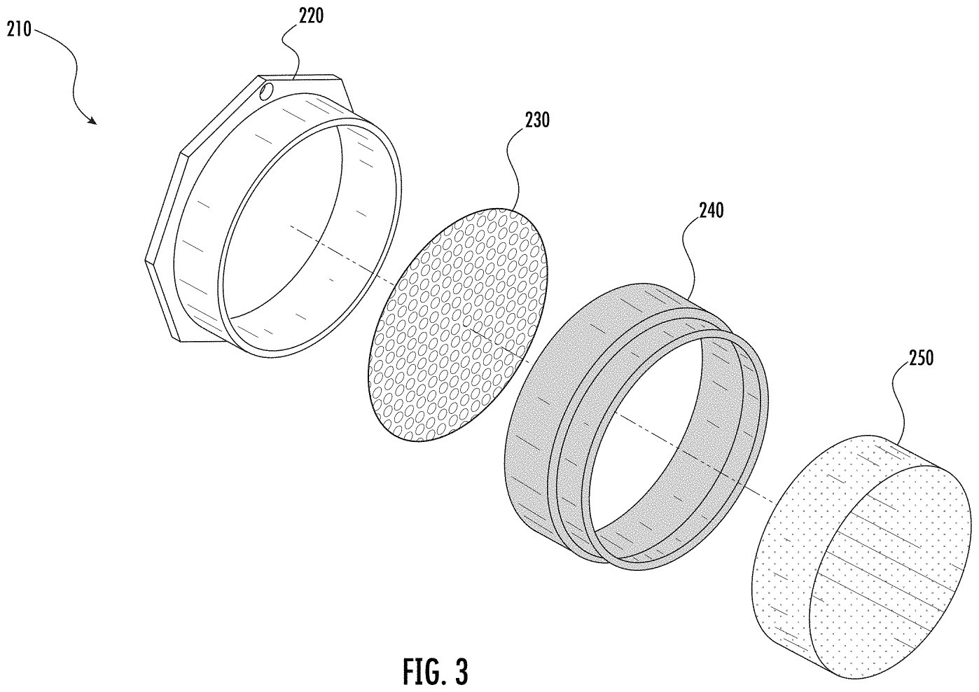

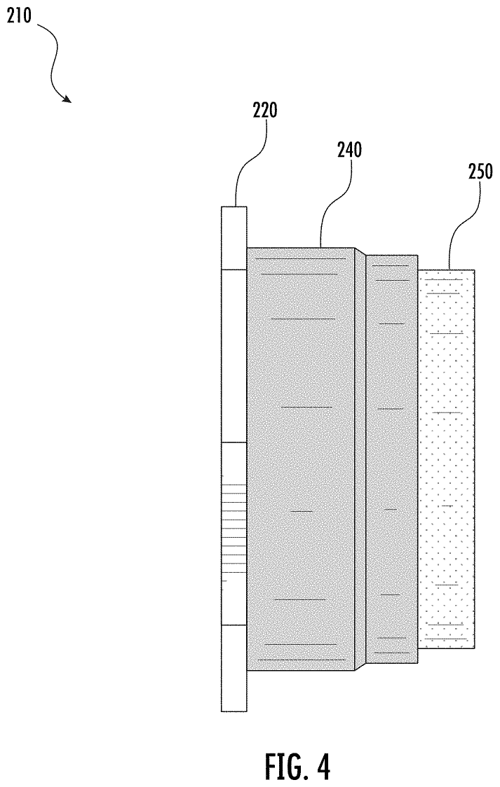

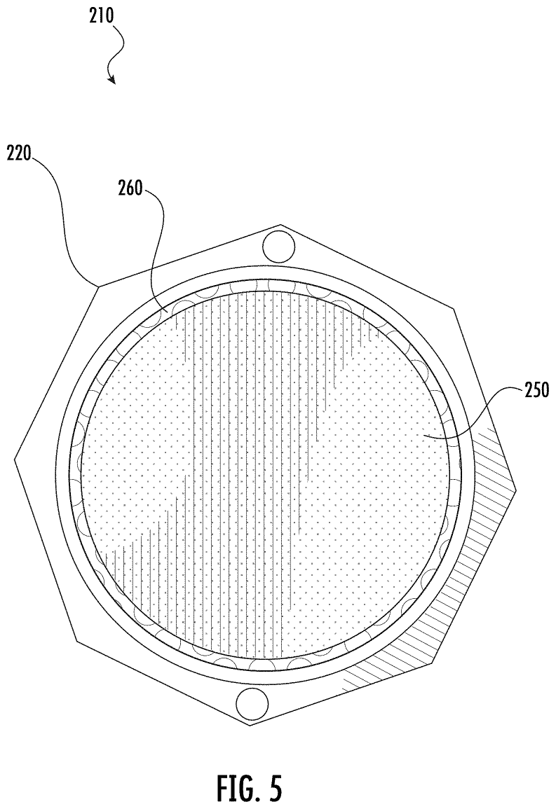

Moving to the other figures, FIG. 2 illustrates an isometric view of a flame arrestor assembly 210. Flame arrestor assembly FIG. 3 is an exploded view of the flame arrestor assembly 210. FIG. 4 illustrates a side view of the flame arrestor assembly 210 of FIG. 2. FIG. 5 illustrates a front view of the flame arrestor assembly 210.

As shown in FIGS. 2-5, an embodiment of the flame arrestor assembly 210 comprises a bung 220, a perforated disk 230, a sleeve 240, a ceramic filter 250, and a perimeter joint 260. The flame arrestor assembly 210 has a perforated disk 230, preferably made of metal, with holes and a ceramic foam insert sealed with silicone gel. The perforated disk 230 has a thickness in a range of 0.01 in. to 0.05 in., preferably 0.030 in. (0.76 mm) thick. The perforated disk 230 has a diameter in a range of 1.5 in. to 3 in., preferably 2½ in. (63.5 mm) diameter. The perforated disk 230 has holes with a hole having a diameter in a range of 0.03 in. to 0.09 in., preferably 0.065 in. (1.65 mm) holes.

As shown in FIG. 5, a perimeter joint 260 is present between ceramic filter 250 and perforated disk 230, and this perimeter joint 260 may be formed from silicone material. The sleeve 240 defines an opening that is capable of receiving at least a portion of the bung 220, the perforated disk 230, the ceramic filter 250, and the perimeter joint 260.

The ceramic filter 250 is preferably comprised of a ceramic foam. The ceramic foam provides the advantages of being flame resistant, non-corrosive, and washable. The anti-corrosive property is additionally advantageous due to potential exposure to chemicals. Additionally, the washable nature of the ceramic filter allows the ceramic filter with proper handling to be used essentially as a permanent filter or at least for much longer-term use. A further advantage of the ceramic filter 250 is that the ceramic filter can collect larger-sized particles. The ceramic foam may be comprised of a zirconia ceramic foam, an alumina ceramic foam, a magnesium oxide ceramic foam, or a silicon carbide ceramic foam. Properties of these various types of filters are summarized in the following table:

TABLE 1

| | Filter Type | | | |
|---|---|---|---|---|
| | | Magnesium | | Silicon |
| | Alumina | Oxide | Zirconia | Carbide |
| Pores per inch | 10-50 | 10-60 | | |
| (“PPI”) | | | | |
| Porosity | 70-95% | 80-90% | 70-80% | 80-90% |
| Density | .35-.5 | .5-.7 | .9-1.2 | .3-.5 |
| (g/cm³) | | | | |

Due to the reactivity of the chemicals being stored in these types of flammable storage cabinets, corrosion is a major concern. Corrosion reduces the conductivity of the material and in some cases may damage the structure. Either case can cause the material to lose functionality. By using a ceramic foam as the material that is cooling the air, corrosion is not an issue. Ceramic is an inert material that does not react with other chemicals, and ceramic has high thermal conductivity. Another method used to stop the passage of flames is to use a mechanical seal that activates in the presence of high temperature. Ceramic acts as a passive barrier and does not have the risk of possible failure by not activating correctly.

In an embodiment of the invention, the arrestor flame assembly having the ceramic foam passes additional testing for flame arrestors, tested according to FM 6050: Approval Standard for Storage Cabinets for Ignitable (Flammable) Liquids—2016. Previous types of metal flame arrestors were rendered ineffective by these new tests. The arrestor assembly having the ceramic foam filter of the present invention has been tested and passes the new criteria.

In an embodiment of the invention, a method of using a flame arrestor assembly comprising a ceramic foam is provided. The method comprises inserting a flame arrestor assembly comprising a ceramic foam in a storage cabinet for ignitable (flammable) liquids.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A storage cabinet for flammable liquids, the storage cabinet for flammable liquids comprising:
an inner wall;
an outer wall; and
a first flame arrestor assembly comprising a ceramic filter, the first flame arrestor assembly being positioned between the inner wall and the outer wall of the storage cabinet for flammable liquids.

2. The storage cabinet for flammable liquids of claim 1, wherein the first flame arrestor assembly further comprises
a bung;
a perforated disk; and
a sleeve.

3. The storage cabinet for flammable liquids of claim 2, wherein the first flame arrestor assembly further comprises a perimeter joint, wherein the sleeve defines an opening where other components may be received, wherein at least a portion of the bung, the perimeter joint, the perforated disk, and the ceramic filter of the first flame arrestor assembly are each received within the sleeve, and wherein the perimeter joint is positioned between the ceramic filter and the perforated disk.

4. The storage cabinet for flammable liquids of claim 1, wherein the ceramic filter comprises a ceramic foam.

5. The storage cabinet for flammable liquids of claim 4, wherein the ceramic filter comprises a ceramic foam selected from the group consisting of zirconia ceramic foam, alumina ceramic foam, magnesium oxide ceramic foam, and silicon carbide ceramic foam.

6. The storage cabinet for flammable liquids of claim 1, wherein the first flame arrestor assembly is positioned so that the ceramic filter is adjacent to the inner wall of the storage cabinet for flammable liquids.

7. The storage cabinet for flammable liquids of claim 6, wherein the inner wall of the storage cabinet for flammable liquids comprises a plurality of holes where the ceramic filter may touch the inner wall of the storage cabinet for flammable liquids.

8. The storage cabinet for flammable liquids of claim 7, wherein each hole within the plurality of holes possesses a diameter ranging from 0.1 inches to 0.4 inches.

9. The storage cabinet for flammable liquids of claim 1, wherein the storage cabinet for flammable liquids defines a bottom surface, and wherein the first flame arrestor assembly is located proximate to the bottom surface of the storage cabinet for flammable liquids.

10. The storage cabinet for flammable liquids of claim 1, wherein the first flame arrestor assembly is located 8 to 10 inches above the bottom surface of the storage cabinet for flammable liquids.

11. The storage cabinet for flammable liquids of claim 8, wherein the storage cabinet for flammable liquids comprises a second flame arrestor assembly.

12. The storage cabinet for flammable liquids of claim 11, wherein the storage cabinet for flammable liquids defines a top surface, and wherein the second flame arrestor assembly is located proximate to the top surface of the storage cabinet for flammable liquids.

13. The storage cabinet for flammable liquids of claim 12, wherein the second flame arrestor assembly is located 6 to 8 inches below the top surface of the storage cabinet for flammable liquids.

14. The storage cabinet for flammable liquids of claim 1, wherein the first flame arrestor assembly generally possesses a cylindrical shape.

15. A method of using a flame arrestor assembly, the method comprising:
inserting a first flame arrestor assembly comprising a ceramic filter into a storage cabinet for flammable liquids.

16. The method of claim 15, wherein the storage cabinet for flammable liquids comprises an inner wall and an outer wall, the method further comprising:
positioning the first flame arrestor assembly so that the ceramic filter touches an inner wall of the storage cabinet for flammable liquids.

17. The method of claim 16, the method further comprising:
securing the first flame arrestor assembly between the inner wall and the outer wall of the storage cabinet for flammable liquids.

18. The method of claim 17, further comprising:
securing the first flame arrestor assembly within the storage cabinet for flammable liquids so that the first flame arrestor assembly is located proximate to a bottom surface of the storage cabinet for flammable liquids.

19. The method of claim 14, further comprising:
inserting a second flame arrestor assembly comprising a ceramic filter into the storage cabinet for flammable liquids;
positioning the second flame arrestor assembly so that the ceramic filter of the second flame arrestor assembly touches the inner wall of the storage cabinet for flammable liquids; and
securing the second flame arrestor assembly between the inner wall and the outer wall of the storage cabinet for flammable liquids.

20. The method of claim 15, further comprising:
securing the second flame arrestor assembly within the storage cabinet for flammable liquids so that the second flame arrestor assembly is located proximate to a top surface of the storage cabinet for flammable liquids.
